(19) United States
(12) Patent Application Publication
(10) Pub. No.: US 2020/0388113 A1
(43) Pub. Date: Dec. 10, 2020

(54) REAL-TIME INTERACTIVE SPORTS PREDICTION GAME

(71) Applicant: Premio LLC, Glendale, CA (US)

(72) Inventors: Haigaz Kazazian, Glendale, CA (US); Mark Pirichian, Chatsworth, CA (US)

(21) Appl. No.: 16/748,736

(22) Filed: Jan. 21, 2020

Related U.S. Application Data
(60) Provisional application No. 62/794,527, filed on Jan. 18, 2019.

(51) Int. Cl. G07F 17/32

(52) U.S. Cl. CPC G07F 17/3288; G07F 17/3227

(57) ABSTRACT

An interactive electronic game is provided which allows users to compete with each other in a contest to make predictions in real time during a live sporting event. The predictions may relate to any activity which occurs during a sporting event, whether the activity is known prior to the beginning of the event or is created during the event as the live sporting event progresses. Users may utilize credits to enter the contest and make predictions, with correct predictions resulting in credits being awarded to the user during or at the end of the contest. Each activity may require different amounts of credits to enter a prediction depending on the difficulty of predicting an outcome, and the contest may be set up to gradually eliminate users at certain points during the contest such that only a few users remain at the end of the contest.

### BACKGROUND

### Field of the Invention

Systems and methods provided herein relate to a real time electronic game for a live sporting event, and more specifically to an interactive electronic game where users compete to correctly predict outcomes in real time during a live sporting event.

### Related Art

Since the inception of most sports, one of the favorite pastimes of many fans is predicting various outcomes of the game, whether it be the final score, a particular player with a highest score, or even an outcome of a coin flip at the beginning of the game. With the advent of digital communications and portable electronic devices, the ability for fans to interact with one another to make these types of predictions has become ubiquitous, whether through fantasy sports games or even gambling websites. Sports leagues and related media have adopted to these “games within the game” by helping fans keep track of the scoring, players and other game data in near real time.

However, there is still a need to develop systems and methods which encourage fans to interact with the games and each other in order to drive interest in the games and let fans get more involved with the games and other fans.

### SUMMARY

Embodiments described herein provide an interactive electronic game which allows users to compete with each other in a contest to make predictions in real time during a live sporting event. The predictions may relate to any activity which occurs during a sporting event, whether the activity is known prior to the beginning of the event or is created during the event as the live sporting event progresses, providing the user with a dynamic, real time interactive game which is as unique as the live event itself. Users may utilize credits to enter the contest and make predictions, with correct predictions resulting in credits being awarded to the user during or at the end of the contest. Each activity may require different amounts of credits to enter a prediction depending on the difficulty of predicting an outcome, and the amount of credits the user receives for predicting a correct outcome for a difficult activity may also be higher than for other activities. Additionally, the contest may be set up to gradually eliminate users at certain points during the contest such that only a few users remain at the end of the contest, allowing eliminated users to enter new contests and providing the remaining users with additional excitement as they get closer to a potential win.

In one embodiment, a method for predicting activities during a live sporting event comprises: selecting, on a portable electronic device, one or more contests related to a live sporting event; selecting, on the portable electronic device, one or more predictions related to activities which may occur during the live sporting event; and receiving a reward for any correct predictions.

In a further embodiment, a system for predicting activities in real time for a live sporting event comprises: a plurality of portable electronic devices configured to select one or more contests and predictions related to activities which may occur during the live sporting event; a contest server which receives the contest selections and prediction selections from the plurality of portable electronic devices; and an event server which transmits information relating to the activities in the live sporting event to the contest server in real time; wherein the contest server utilizes the information relating to the activities in the live sporting event to determine if any of the selected predictions are correct.

Other features and advantages of the present invention will become more readily apparent to those of ordinary skill in the art after reviewing the following detailed description and accompanying drawings.

### BRIEF DESCRIPTION OF THE DRAWINGS

The structure and operation of the present invention will be understood from a review of the following detailed description and the accompanying drawings in which like reference numerals refer to like parts and in which:

FIG. 1 is a network diagram illustrating an example system for playing an interactive electronic game, according to an embodiment of the invention;

FIG. 2 is a block diagram illustrating an example method of implementing the interactive electronic game system, according to an embodiment of the invention;

FIG. 3 is a block diagram illustrating an example a method of participating in the interactive electronic game, according to an embodiment of the invention;

FIG. 4 is a graphical user interface (GUI) image of a home page of the interactive electronic game, according to one embodiment of the invention;

FIG. 5 is a GUI image of a user rankings page of the interactive electronic game, according to one embodiment of the invention;

FIG. 6 is a GUI image of a games page of the interactive electronic game, according to one embodiment of the invention;

FIG. 7 is a GUI image of a news page of the interactive electronic game, according to one embodiment of the invention;

FIG. 8 is a GUI image of a friends page of the interactive electronic game, according to one embodiment of the invention;

FIG. 9 is a GUI image of a contest and event page of the interactive electronic game, according to one embodiment of the invention;

FIG. 10 is a GUI image of a contest selection page of the interactive electronic game, according to one embodiment of the invention;

FIG. 11 is a GUI image of a contest results page of the interactive electronic game, according to one embodiment of the invention;

FIG. 12 is a GUI image of an in-game event rankings page of the interactive electronic game, according to one embodiment of the invention;

FIG. 13 is a GUI image of a fee and account management page of the interactive electronic game, according to one embodiment of the invention;

FIG. 14 is a GUI image of an interactive messaging page of the interactive electronic game, according to one embodiment of the invention; and

FIG. 15 is a block diagram illustrating an example wired or wireless processor enabled device that may be used in connection with various embodiments described herein.

### DETAILED DESCRIPTION

Certain embodiments disclosed herein provide for an interactive electronic game which allows users to make predictions in real time during a live sporting event and compete with other users in one or more contests during the event. For example, one method disclosed herein allows for users to obtain credits which can be used to enter a contest where a number of different predictions can be made during a live sporting event, from predicting which team or player will score first to the score of the game after a certain period or quarter has elapsed. Correct predictions will reward the user with credits or advancement to further rounds in the contest, with more difficult predictions providing larger rewards. Users who make the most correct predictions or earn the most credits from their successful predictions are deemed the winners of the contest and may receive additional credits or a monetary award.

Since the contests are conducted during a live sporting event, the users who participate in the contests will also be viewing the sporting event live, increasing the user's interaction with the event and other users who are also watching the event and playing the game. Additionally, the types of predictions that can be made during the contests will change dynamically as the game progresses, with certain types of predictions becoming available only if certain circumstances occur in the event to make that prediction a possibility. This provides an additional dynamic nature to the contests that keep users engaged with the contests and the live sporting event.

The interactive electronic game may be played on any electronic device, but may be particularly configured for use on a portable electronic device—such as a smart phone—to allow the user to easily play the game while watching the live sporting event from any location using a separate device such as a television or monitor. However, the game may also be integrated into a user's viewing experience on a single display device so the user can view and enter contests with a single device that is also being used to watch the live sporting event—such as a smartphone with an integrated graphical user interface (GUI) which includes contest and prediction information alongside the video of the live sporting event. Similarly, a smart television may also be configured with an integrated GUI which displays the game information along with the video of the live sporting event.

The contests may also vary depending on the type of sporting event and the type of contest that a user selects, as certain contests may require entry fees while others are free depending on the type of award that the winners are interested in. Additionally, some contests may eliminate users as the contest progresses, with users who fail to accumulate a minimum number of correct predictions within a certain period of the event being eliminated from the event while users who continue to make successful predictions advance to final periods of the event.

After reading this description it will become apparent to one skilled in the art how to implement the invention in various alternative embodiments and alternative applications. However, although various embodiments of the present invention will be described herein, it is understood that these embodiments are presented by way of example only, and not limitation. As such, this detailed description of various alternative embodiments should not be construed to limit the scope or breadth of the present invention as set forth in the appended claims.

### I. Interactive Electronic Game System

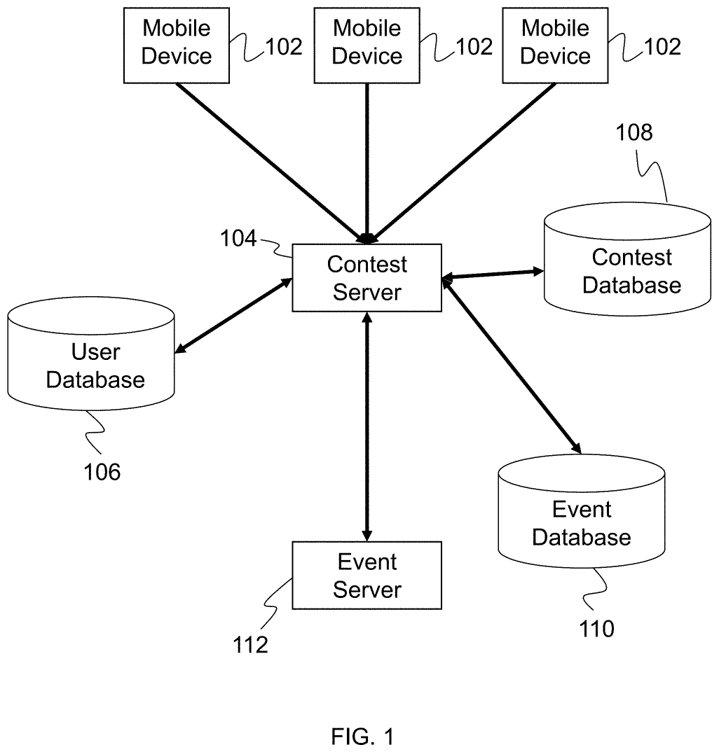

One embodiment of a system for providing an interactive electronic game is illustrated in FIG. 1. A plurality of mobile devices 102 may be utilized by users who want to play the game, where the mobile device 102 may be any type of portable electronic device such as a smart phone, tablet, laptop, etc. which allows the user to play the game from any location. While mobile devices are described throughout this description, any type of computing device with an Internet connection—such as a desktop, smart display, etc.—may be utilized. The mobile devices 102 may provide access to the game via a customized application loaded on the mobile device 102 or via an Internet browser on the mobile device 102 which accesses a website with a user interface for participating in the game.

The mobile devices 102 may receive game information from at least one contest server 104, which includes information on the contests, predictions for each contest, real time event information, user profiles and scores, etc. The contest server 104 may be connected with one or more databases which store the information required for the game, such as a user database 106 and contest database 108. The user database 106 may store information pertaining to the users, including identification information, device information, points and credits, etc., while the contest database 108 may store information on the contests, predictions, point values and related events. An event database 110 may store information on all of the live sporting events, including the scores and other statistics that are the subject of the contests. All of this information may be transmitted between the contest server 104 and the mobile devices 102 before, during and after the live sporting events so the users can continuously monitor their progress during the contests and manage their credits, rewards, profiles, etc. at any time.

In one embodiment, an event server 112 may be utilized to retrieve data related to the live sporting events for use by the contest server 104 in managing and executing all of the contests and predictions. The event server 112 may be controlled by an independent third party to ensure the accuracy and timeliness of the data for the live sporting events. Furthermore, if the game is integrated with a live video broadcast of the sporting event, the event server 112 may also provide the video content in addition to the event content.

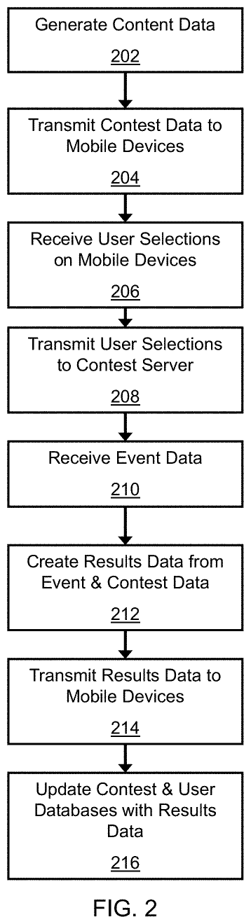

A method of implementing the interactive electronic game system is provided in FIG. 2. In step 202, the contest server 104 generates content information on one or more contests for a live sporting event, and in step 204, transmits the contest information to a plurality of mobile devices 102 for the mobile device users to view. In step 206, the users can then select one or more of the contests to enter and select predictions for that contest via the mobile devices 102, after which, in step 208, the user selections are transmitted back to the contest server 104. In step 210, the contest begins when the live sporting event begins, which means the contest server 104 receives event data from the event server 112 as the activities which occur during the live sporting event take place. In step 212, results data is created at the contest server 104 by analyzing the various predictions made from the content data and comparing it with the event data generated during the contest to determine which predictions were correct and which users should be awarded points, moved to additional rounds, determined to be winners, etc. Step 212 may be ongoing during the length of the event as activities occur—and even after the end of the event—as the final points and rewards are totaled. In step 214, the results data is transmitted to the mobile devices 102 for viewing by the users in real time during the live sporting event, as well as after the event when the winners are determined and the users are notified. In step 216, the results data may be transmitted to the contest database 108 to store the overall results from the contest, and transmitted to the user database 106 to update user profiles with credits earned, money spent, rewards earned, etc.

It will be appreciated by one of skill in the art that any or all of the databases and servers described in the exemplary system may be combined into a single server and a single database which manages the game and all of the content related thereto. Similarly, a system managing a large amount of users, devices, content and event information in a variety of locations may require a plurality of contest servers, event servers and databases to effectively manage the game and ensure that communication between the users and the contest servers can be carried out in real time during any live sporting event.

### II. Game Play Methodology

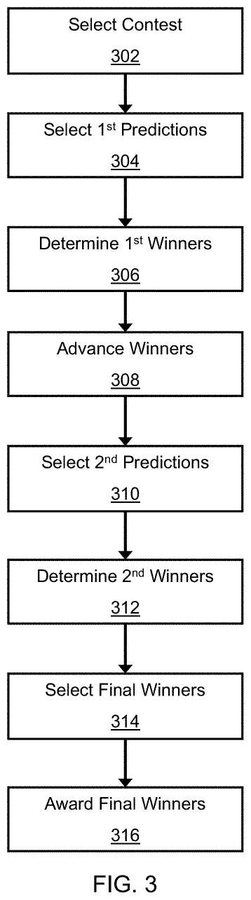

Various methods will be described below for carrying out the interactive electronic game, although all of the methods provide a live sporting event and real time participation by a plurality of users to make predictions relating to the activities which take place during the live sporting event. FIG. 3 illustrates the steps for one embodiment of a method of predicting activities for a live sporting event in real time, beginning with step 302 where a user selects a contest relating to a live sporting event. In step 304, the user then selects a first set of predictions during the live sporting event from a first set of possible activities which have not yet occurred. The activities may be possible actions, events, outcomes, etc. that could possibly occur during a first time period of the live sporting event, such as a score by a certain team during a first quarter of a football game. The users are all given a specified amount of time to enter their predictions prior to the start of the time period of the game during which the activity may occur, and once the time period begins, the users can no longer select any of the predictions on the current set. In step 306, after the time period pertaining to the contest ends, the system determines which users made successful predictions and awards the winners. Winners may be selected based on any type of criteria, whether it be a certain number of correct predictions, a certain amount of points earned from the selected predictions, or simply a threshold level of points or correct predictions.

In step 308, the winners are awarded by advancing to a second round of the contest while the remaining set of users who did not meet the criteria of winners are eliminated from the contest. In step 310, a second set of possible activities are generated based on the current progress and status of the game and the remaining users select a second set of predictions from the second set of activities. The second set of possible activities are those which are likely to occur during a second time period of the live sporting event. In step 312, the after expiration of the second time period, a second set of winners is selected based the criteria for the given contest, such as the number of points earned from successful predictions or the number of successful predictions made. The remaining users who did not become part of the second set of winners are then eliminated, leaving a smaller group of second winners.

The aforementioned steps 304-312 may be repeated any number of times depending on how the live sporting event is organized or how the contest is organized. For example, if a football game typically has four quarters, there may be four rounds of the contest during which four sets of predictions are selected and the winners are further narrowed. In step 314, after all of the periods of the live sporting event and/or contest have been completed, a final set of winners is selected. This may be considered all of the users remaining after the final time period and elimination step, or it may be only a certain few users within the final set of winners, such as the top three users. In one example, if the winners are selected based on a threshold number of points earned during the contest, there may be numerous winners who each receive the same award, or the winners may have to divide up the total award amongst each other. In step 316, the final winners are awarded with either points, monetary awards or other benefits, and the user profiles and accounts of the winners are updated.

In another embodiment, the interactive electronic game is organized into a contest, and when users select the contest on their electronic device, they are entered into a contest zone with the other participants. A clock will appear and begin a countdown that expires a short period of time after the game is scheduled to begin (i.e. 5 minutes). Once the clock expires, the contest begins and the contestants are presented with one or more propositions (“props”) pertaining to predictions of activities that may occur during the live sporting event. Each prop may have a unique point value which corresponds to the amount of points the contestant will earn if they select that prop and the prop actually occurs. As previously discussed, different props may have different point values based on the difficulty of making the prediction related to the prop, or pertaining to the likelihood that a prop will occur during the event. The contestants must strategically select props based on how many points they want to earn in order to win or advance to the next round of the contest, balanced by the risk of selecting props with high point values that are more difficult to predict or less likely to occur.

In one scenario, the contestants may receive a list of props and be required to select half of the props, thus requiring additional strategy since the contestant needs to select a certain amount of props and must again balance the selection of props with high point values and high risk versus props with low point values and low risk.

When the live sporting event concludes, the contestants are awarded points for the propositions which occurred, and in some cases, may lose points for propositions they selected which did not occur. The system will then eliminate contestants who did not achieve a certain threshold value of points to win the contest or move on to the next round of the contest. It is also possible that a single contest may take place over the course of several live sporting events, such that each round of the contest pertains to a new live sporting event and concludes after a series of the sporting events has concluded (ex: a 7 game playoff series in basketball or baseball). If the contest has multiple rounds, the contest continues with the remaining contestants until a final round, after which the contestants who earn the highest amount of points are determined to be the winners and awarded prizes.

### III. Graphical User Interfaces (GUIs)

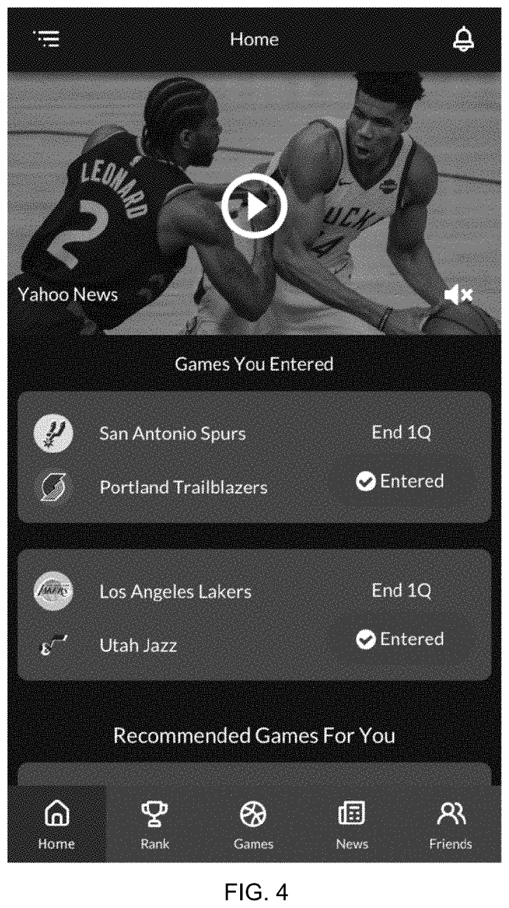

FIG. 4 is a graphical user interface (GUI) image of a home page of the interactive electronic game, according to one embodiment of the invention. The home page provides a summary of events (games) and contests that the user has entered, recommendations for additional events to enter, and other useful features such as video highlights of games and news related to the sport or particular event. Additional menu options on a menu bar at the bottom of the home page provide options to get to the home page, view a user's ranking amongst other users, find additional games and contests to enter, news, and an option to view friends within the game that a user might regularly play with or against. Additional menu options and alert options and notifications are provided by the icons on the top of the GUI.

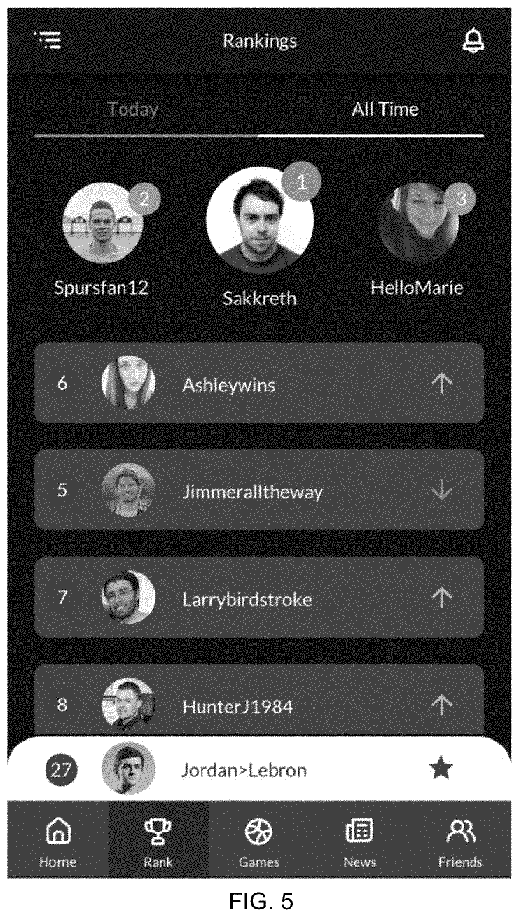

FIG. 5 is a GUI image of a user rankings page of the interactive electronic game, according to one embodiment of the invention. The rankings page may show current or final rankings in one or more contests related to an event, including showing the top three (3) finalists in a contest at the top of the page and additional rankings below the top three. The user's ranking will also be displayed on a status bar above the menu bar at the bottom of the page, particularly if the user is not in the top list of finalists already displayed. The rankings page also provides options to show user rankings for the current day or all time.

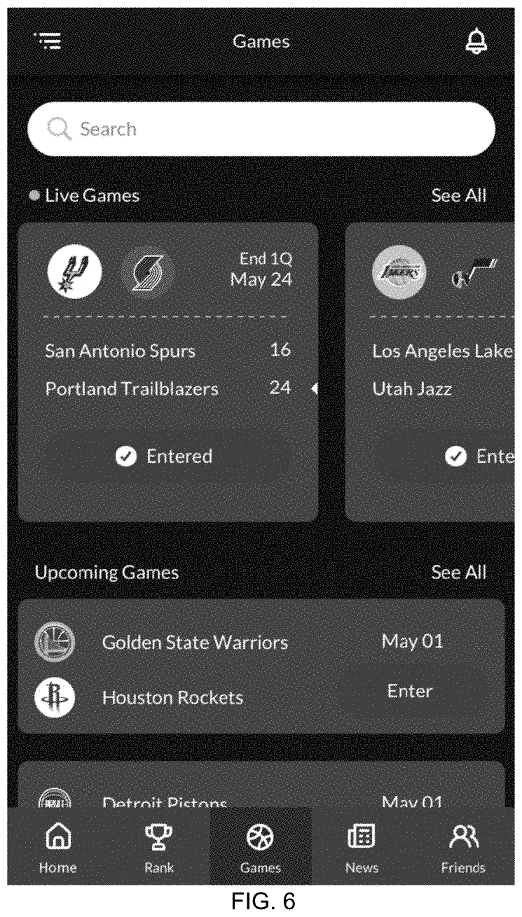

FIG. 6 is a GUI image of a games page of the interactive electronic game, according to one embodiment of the invention. The games page displays options to search for games (events), an area which displays current games that are in progress and games which are upcoming, and whether or not the user has entered a contest related to a game. The user may select a game to view and enter the contests related to that game.

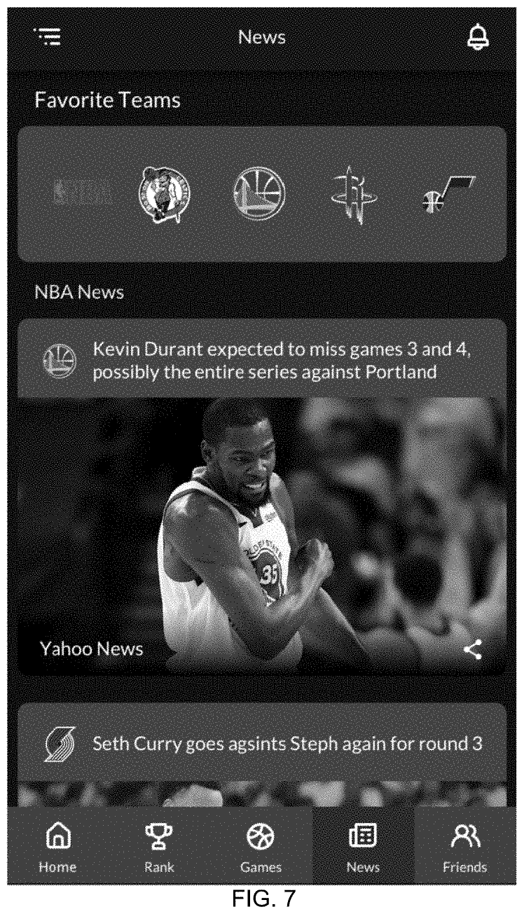

FIG. 7 is a GUI image of a news page of the interactive electronic game, according to one embodiment of the invention. The news page may be customized to display a user's favorite teams in order to allow the user to easily find games, contests, news and other content for those teams. News articles or videos may also be displayed which are related to games the user is considering entering or for teams or sports the user is interested in entering.

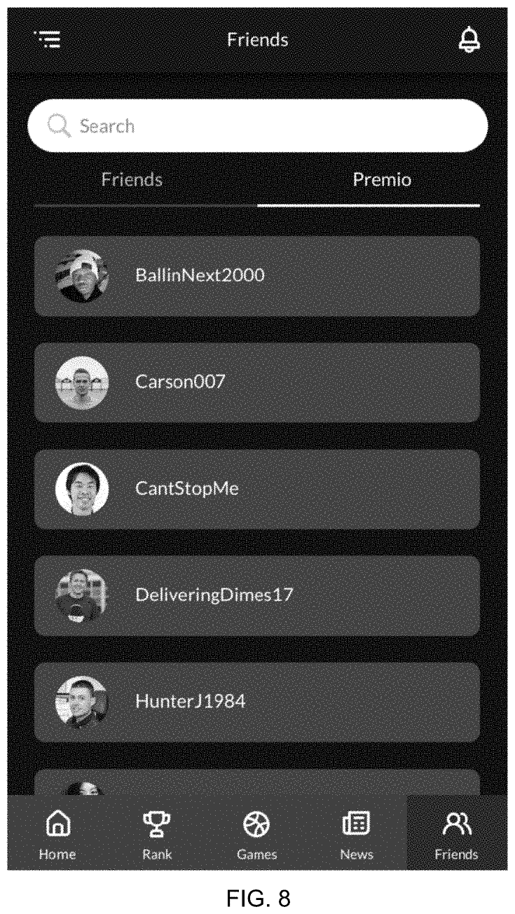

FIG. 8 is a GUI image of a friends page of the interactive electronic game, according to one embodiment of the invention. The friends page provides a list of the users' friends which use the interactive electronic game. The user can invite friends from outside the interactive electronic game through social media, contacts on their phone or e-mail, etc. and then enter contests with or against their friends to increase their interest in a particular game or contest.

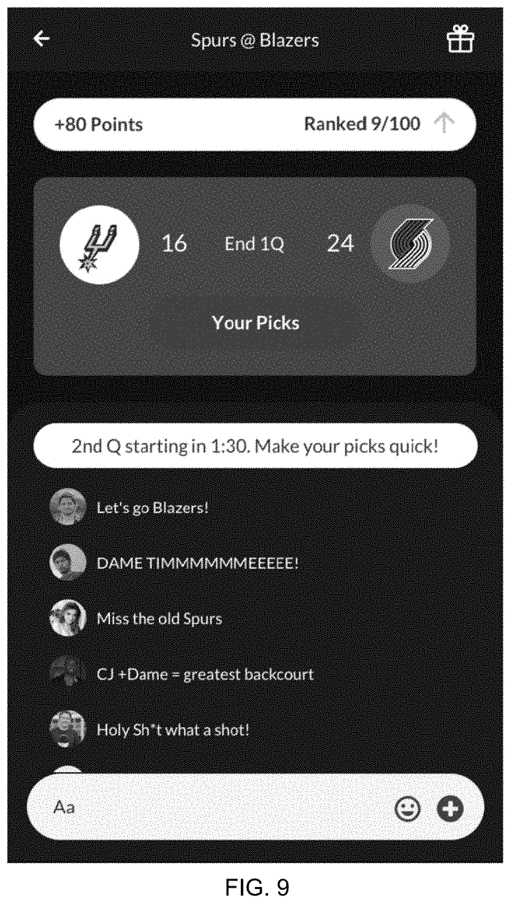

FIG. 9 is a GUI image of a contest and event page of the interactive electronic game, according to one embodiment of the invention. The contest page may show the user's rank amongst other users in one or more contests, the number of points earned, a summary of the sporting event, options to view the contests the user entered for that particular event, messaging about additional events that the user may enter, and a messaging space where the users can message each other during the contests. In one embodiment, the users may be able to view the sporting event on the contest page as well.

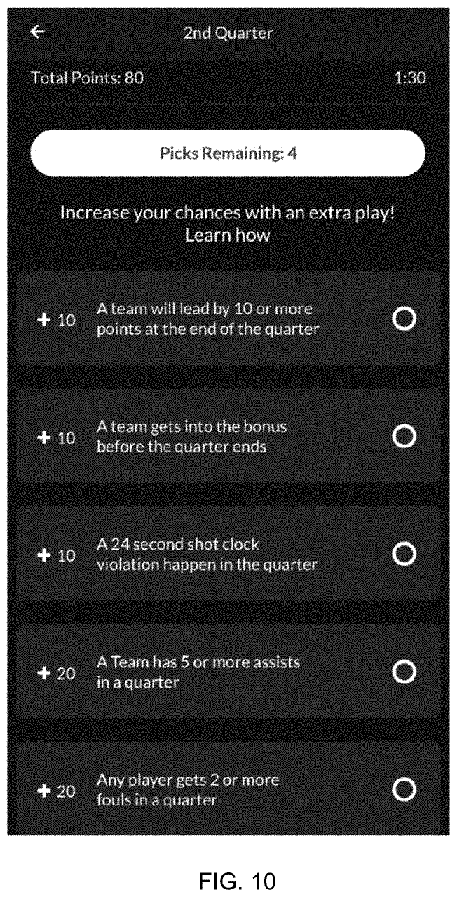

FIG. 10 is a GUI image of a contest selection page of the interactive electronic game, according to one embodiment of the invention. The contest selection page lists one or more contests related to an event that the user may enter, along with a point value associated with correctly picking the outcome of that contest. For example, the user may select a contest that “A team will lead by 10 or more points at the end of the quarter” and receive 10 points if their prediction is correct. As previously described, some contests are worth more points, particularly if the subject of the contest is more difficult to predict or more unlikely to occur. The contest selection page may also provide a user with a maximum number of contests which they are allowed to enter and provide a summary of the number of picks remaining for that particular contest. A maximum number of contests may increase the difficulty of winning by forcing the user to select certain contests which are worth more points in order to achieve a higher score than other users.

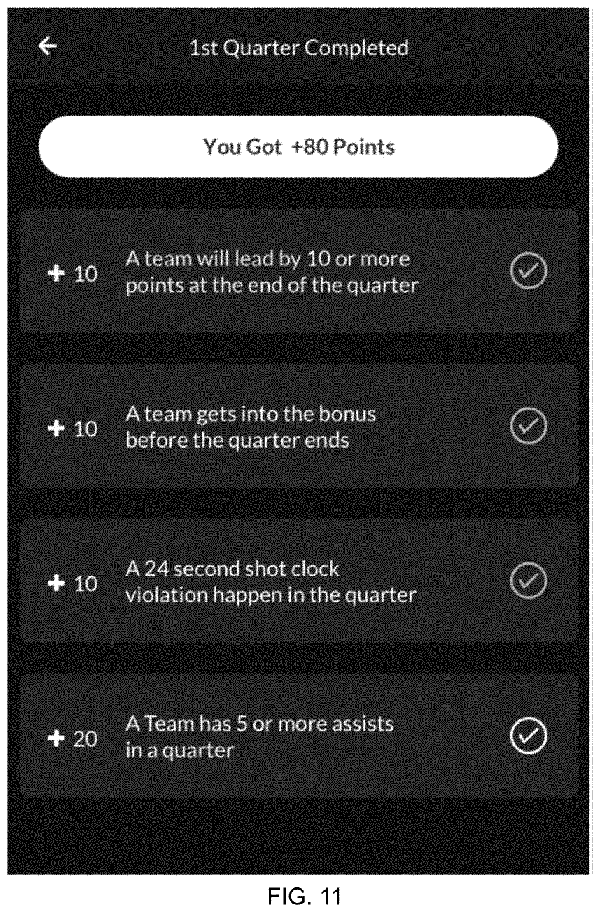

FIG. 11 is a GUI image of a contest results page of the interactive electronic game, according to one embodiment of the invention. The contests results page lists the contests which the user entered and how many points the user won or didn't win with their correct or incorrect predictions. In this example, a view of several contests related to a 1st quarter of a sporting event is displayed along with the point value and an identifier (such as a green check box) if the selection was correct.

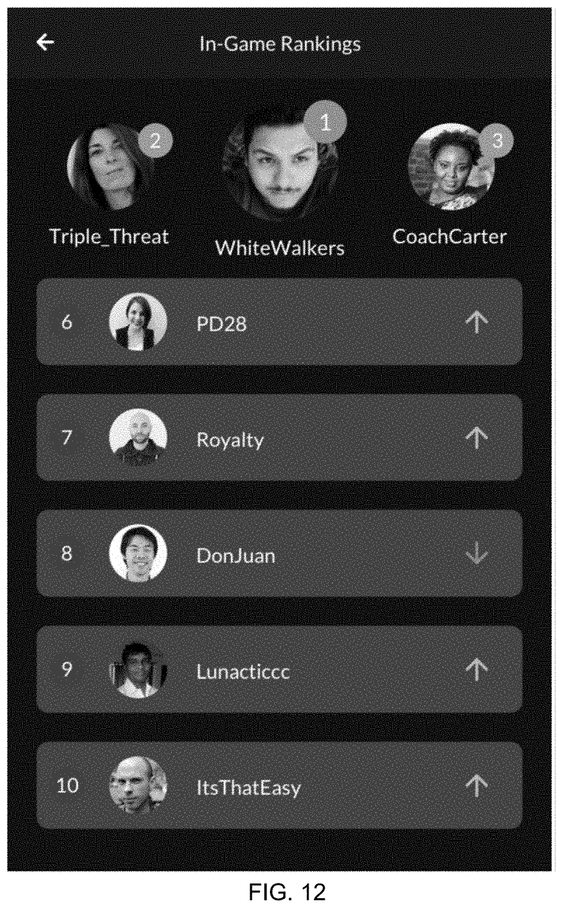

FIG. 12 is a GUI image of an in-game event rankings page of the interactive electronic game, according to one embodiment of the invention. These rankings reflect a real-time determination of which users and winning a particular contest or group of contests in part or all of a sporting event. As the contests within the sporting event conclude, the rankings will change, and additional indicators of whether a user is moving up or down in the rankings may be shown by directional arrows within the graphic provided for each user.

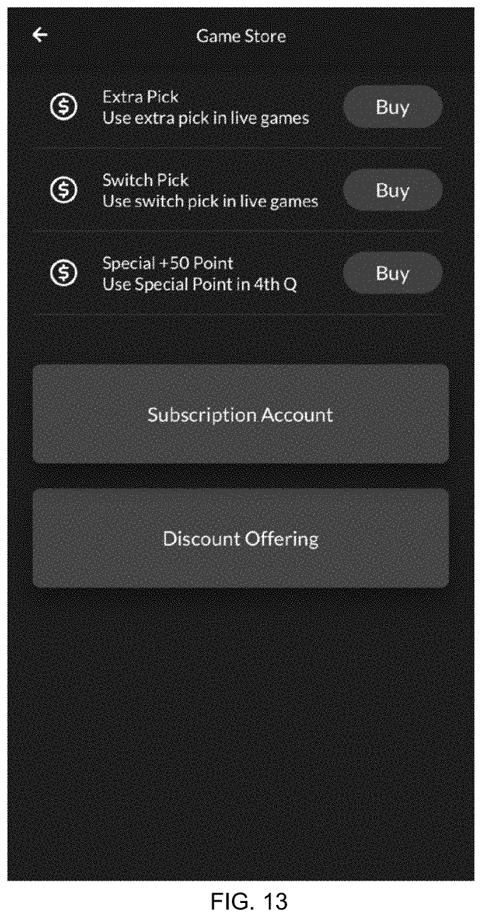

FIG. 13 is a GUI image of a fee and account management page of the interactive electronic game, according to one embodiment of the invention. Here, the user is able to purchase additional credits to play in additional contests, create or maintain a subscription to the interactive electronic game, view or enter discounts for entries into contests, and otherwise manage their account within the interactive electronic game.

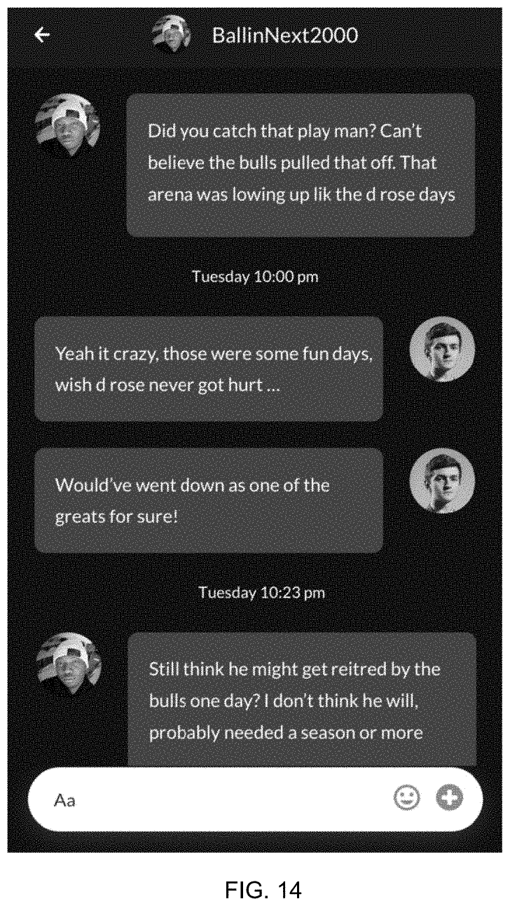

FIG. 14 is a GUI image of an interactive messaging page of the interactive electronic game, according to one embodiment of the invention. The messaging page will allow the user to interact with other users and friends within the interactive electronic game regardless of whether there is a game or contest in progress.

### IV. Computer-Enabled Embodiment

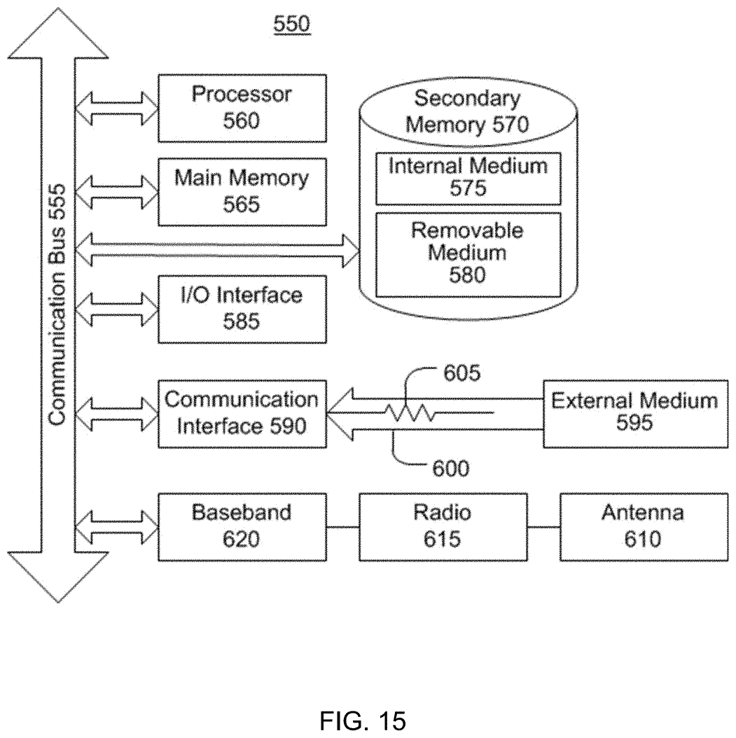

FIG. 15 is a block diagram illustrating an example wired or wireless system 550 that may be used in connection with various embodiments described herein. For example the system 550 may be used as or in conjunction with a an interactive game for predicting activities in a live sporting event, as previously described with respect to FIGS. 1-14. The system 550 can be a conventional personal computer, computer server, personal digital assistant, smart phone, tablet computer, or any other processor enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PCI”) local bus, or standards promulgated by the Institute of Electrical and Electronics Engineers (“IEEE”) including IEEE 488 general-purpose interface bus (“GPIB”), IEEE 696/S-100, and the like.

System 550 preferably includes a main memory 565 and may also include a secondary memory 570. The main memory 565 provides storage of instructions and data for programs executing on the processor 560. The main memory 565 is typically semiconductor-based memory such as dynamic random access memory (“DRAM”) and/or static random access memory (“SRAM”). Other semiconductor-based memory types include, for example, synchronous dynamic random access memory (“SDRAM”), Rambus dynamic random access memory (“RDRAM”), ferroelectric random access memory (“FRAM”), and the like, including read only memory (“ROM”).

The secondary memory 570 may optionally include a internal memory 575 and/or a removable medium 580, for example a floppy disk drive, a magnetic tape drive, a compact disc (“CD”) drive, a digital versatile disc (“DVD”) drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 570. Examples of external storage medium 595 may include an external hard disk drive or an external optical drive, or and external magneto-optical drive.

Other examples of secondary memory 570 may include semiconductor-based memory such as programmable read-only memory (“PROM”), erasable programmable read-only memory (“EPROM”), electrically erasable read-only memory (“EEPROM”), or flash memory (block oriented memory similar to EEPROM). Also included are any other removable storage media 580 and communication interface 590, which allow software and data to be transferred from an external medium 595 to the system 550.

System 550 may also include an input/output (“I/O”) interface 585. The I/O interface 585 facilitates input from and output to external devices. For example the I/O interface 585 may receive input from a keyboard or mouse and may provide output to a display. The I/O interface 585 is capable of facilitating input from and output to various alternative types of human interface and machine interface devices alike.

System 550 may also include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a modem, a network interface card (“NIC”), a wireless data card, a communications port, a PCMCIA slot and card, an infrared interface, and an IEEE 1394 fire-wire, just to name a few.

Communication interface 590 preferably implements industry promulgated protocol standards, such as Ethernet IEEE 802 standards, Fiber Channel, digital subscriber line (“DSL”), asynchronous digital subscriber line (“ADSL”), frame relay, asynchronous transfer mode (“ATM”), integrated digital services network (“ISDN”), personal communications services (“PCS”), transmission control protocol/Internet protocol (“TCP/IP”), serial line Internet protocol/point to point protocol (“SLIP/PPP”), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

The system 550 also includes optional wireless communication components that facilitate wireless communication over a voice and over a data network. The wireless communication components comprise an antenna system 610, a radio system 615 and a baseband system 620. In the system 550, radio frequency (“RF”) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (“IC”). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown) that are executable by processor 560.

Various embodiments may also be implemented primarily in hardware using, for example, components such as application specific integrated circuits (“ASICs”), or field programmable gate arrays (“FPGAs”). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, and methods described in connection with the embodiments disclosed herein can be implemented or performed with a general purpose processor, a digital signal processor (“DSP”), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

The above description of the disclosed embodiments is provided to enable any person skilled in the art to make or use the invention. Various modifications to these embodiments will be readily apparent to those skilled in the art, and the generic principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

What is claimed is:

1. A method for predicting activities during a live sporting event, the method comprising the steps of:
selecting, on a portable electronic device, one or more contests related to a live sporting event;
selecting, on the portable electronic device, one or more predictions related to activities which may occur during the live sporting event; and
receiving a reward for any correct predictions.

2. A system for predicting activities in real time for a live sporting event, the system comprising:
a plurality of portable electronic devices configured to select one or more contests and predictions related to activities which may occur during the live sporting event;
a contest server which receives the contest selections and prediction selections from the plurality of portable electronic devices; and
an event server which transmits information relating to the activities in the live sporting event to the contest server in real time;
wherein the contest server utilizes the information relating to the activities in the live sporting event to determine if any of the selected predictions are correct.
